(19) United States
(12) Patent Application Publication
(10) Pub. No.: US 2008/0252453 A1
(43) Pub. Date: Oct. 16, 2008

(54) Monitoring Device, Carrier Device and Method Involving Monitoring Device and a Carrier Device

(76) Inventor: Tor-Bjorn Hallberg, Solna (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 10/597,581

(22) PCT Filed: Oct. 14, 2004
(86) PCT No.: PCT/SE2004/001474

§ 371 Date: Jul. 31, 2006

(30) Foreign Application Priority Data
Mar. 22, 2004 (SE) 0400720-9

(51) Int. Cl. G08B 13/14

(52) U.S. Cl. 340/571

(57) ABSTRACT

A method for monitoring the presence of a monitored item. A poll signal is transmitted from a monitoring device arranged in a mobile telephone or similar, to a carrier device arranged on the monitored item. The poll signal has predetermined characteristics identifying the monitoring device and the carrier device. A response signal is transmitted from the carrier device to the monitoring device in response to the poll signal the response signal enables the monitoring device to identify and determine the position of the carrier device. Action is taken if it is determined that the distance between the monitoring device and the carrier device is greater than a predetermined threshold distance. Theft or loss of valuable items can be detected if they are provided with carrier devices according to the present invention.

### TECHNICAL FIELD

The present invention relates to a monitoring device as defined in the preamble of claim 1. It also relates to a carrier device as defined in the preamble of claim 13 and a method for monitoring the presence of a monitored item, as defined in the preamble of claim 22.

### BACKGROUND

There is a desire to be able to discover loss or theft of personal belongings, especially valuables, at an early stage. The early discovery of a theft is of importance for capturing the thief. Similarly, there is a desire to prevent unauthorized use of functional items such as credit cards or remote control devices.

### OBJECT OF THE INVENTION

It is an object of the present invention to detect the loss of personal effects, in particular valuables, at an early stage.

### SUMMARY OF THE INVENTION

This object is achieved according to the invention by a portable monitoring device characterized in that it is comprises
monitoring means for monitoring the presence of at least one monitored item, said monitoring means comprising
polling means for transmitting a poll signal to at least one carrier device arranged on a monitored item, said poll signal having predetermined characteristics identifying the monitoring device and the carrier
receiving means for receiving a response signal from the monitored item
position means for identifying the monitored item on the basis of characteristics of the response signal.

In a preferred embodiment the position means is arranged to determine the position of the monitored item on the basis of characteristics of the response signal.

The object is also achieved by a carrier device arranged to be placed on a monitored item and comprising
receiving means for receiving a poll signal from a monitoring device, said poll signal having predetermined characteristics identifying the monitoring device and the carrier
response means for transmitting a response signal to the monitoring device, said response signal enabling the monitoring device to identify the carrier device.

In a preferred embodiment the response means is arranged to transmit the response signal in response to the poll signal.

The response signal preferably enables the monitoring device to determine the position of the carrier device.

The object is also achieved by a method for monitoring the presence of a monitored item comprising the steps of
transmitting a poll signal from a monitoring device to a carrier device arranged on the monitored item, said poll signal having predetermined characteristics identifying the monitoring device and the carrier device,
transmitting a response signal from the carrier device to the monitoring device, said response signal enabling the monitoring device to determine the position of the carrier device
taking action if it is determined that the distance between the monitoring device and the carrier device is greater than a predetermined threshold distance.

The carrier device is arranged in or on a monitored item, such as a credit card or other valuable. The monitoring device is preferably arranged in a mobile telephone, so that the communication functions of the mobile phone can be utilized. It could also be arranged in another type of portable unit, such as a laptop computer or a personal digital assistant, preferably comprising communication functions. In this way the monitoring device monitors the distance between the mobile telephone, or other portable unit, and the monitored item. If the item or the mobile telephone is lost or stolen, and the distance between them increases above a predefined threshold distance, action will be taken. Action may also be taken if no poll signal is received in the carrier device, or if no response signal is received in the monitoring device, within a predetermined period of time. The threshold distance may be set as required but should be selected so that it is longer than the maximum normal distance between the monitoring device and the carrier, but short enough to detect the loss or theft at an early stage. This means that the threshold distance will typically be between 1 and 30 meters.

The action can involve issuing an alarm and/or deactivating the function of the monitored item, for example the chip and/or magnetic strip of the credit card. The function may be deactivated by a deactivating means in the carrier device of its own motion, for example if no poll signal is received in a predefined period of time. It may also be deactivated in response to a deactivating signal received in the carrier device from the monitoring device. Deactivating the function of the monitored item ensures that a person who takes unauthorized possession of the item cannot use it. Deactivation may be permanent or temporary. In the latter case the function of the monitored item may be reactivated if a new poll signal is received from the appropriate monitoring device.

The action may also involve activating a camera for recording still or moving images, which may capture the situation and help identify, for example, a pickpocket. Sound recordings may be initiated as well. This will be particularly useful if the threshold distance is set relatively short, for example 1 meter. Thus, the invention may serve both to discover loss or theft, to document the circumstances of the loss or theft, and to prevent unauthorized use of items such as credit cards, key cards or remote control devices.

For example, if the carrier is moving in the wrong direction, or the monitoring device is moved out of reach, the monitoring device can be arranged to act in different ways. For example, in a first step, the monitoring device may issue an alarm to the user, then deactivate the functional units of the portable unit on which it is arranged in a second step. As a third step, the camera may be started. In addition to the alarm to the user, a call may be set up through a telecommunications network, for example, to a security company or to the police. The actions taken, as well as the order, may be varied as desired.

For the communication between the monitoring device and the carrier device a short-range transmitter may be used. For example, Bluetooth will be suitable in this context. Alternatively, the polling means may be arranged to transmit the poll signal on a radio frequency or by means of a communications network. The control means of the monitoring device may be arranged to control the communication facilities of the portable unit on which the monitoring device is arranged, for example, to transmit signals through the telecommunications network using the transmitter of the mobile telephone.

The monitoring device according to the invention could also be used for remote control of technical equipment. For example entrance codes could be replaced with a poll signal with a particular characteristic. The entrance control could be activated at a distance and the door could be opened when the user approaches. For increased security the remote control could be combined with entering a key code, so that both the appropriate poll signal and the key code would be required for the door to open.

### BRIEF DESCRIPTION OF THE DRAWINGS

The present invention will be described in more detail in the following, with reference to the appended drawings, in which:

FIG. 1 is an overview of a system according to the invention

FIG. 2 shows a monitoring device used according to the invention

FIG. 3 shows a carrier device used according to the invention

FIG. 4 is a flow chart of the method according to the invention.

### DETAILED DESCRIPTION OF EMBODIMENTS

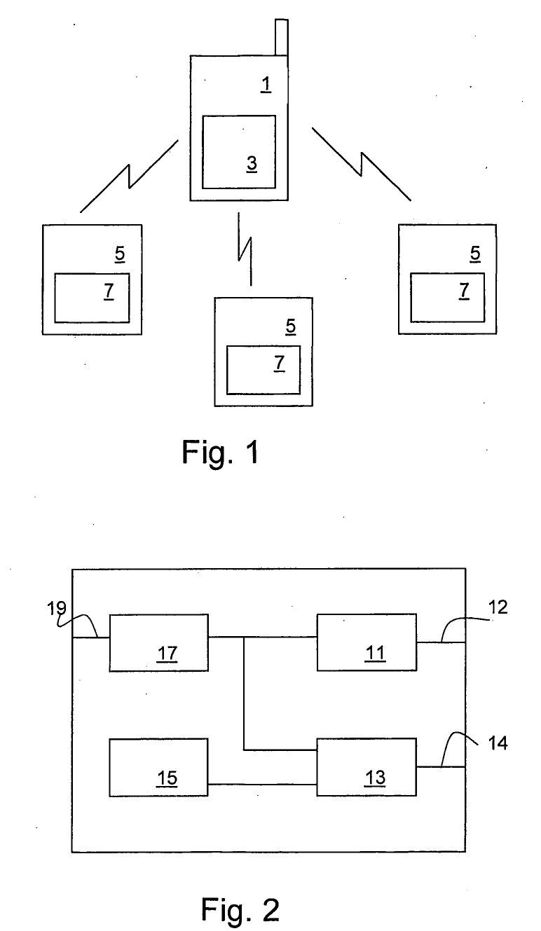

FIG. 1 illustrates a basic embodiment of a system according to the invention. A mobile telephone 1 comprises, in addition to the units normally comprised in the telephone (not shown), a monitoring device 3. The monitoring device will be discussed in more detail in connection with FIG. 2. The system also comprises several monitored items 5 that should be registered by the monitoring device. Each item 5 comprises a carrier device 7 arranged to communicate with the monitoring device 3, as will be described in more detail below. The items may comprise one or more of the following: credit cards, key cards, wallets, remote control units and other items that should be monitored. A person using the system would carry the mobile telephone and one or more monitored items and make sure they are kept within a specified distance of each other.

The monitoring device is arranged to transmit a poll signal to each of the carrier devices 7 at regular time intervals. Each carrier device has a unique signal profile to be used in the poll signal. The monitoring device can generate signals according to each of these profiles, to communicate with each of the carrier devices. The carrier device will respond to the monitoring device by transmitting a response signal using its own profile. Alternatively, the same signal from the monitoring device is received in all carrier units, but each carrier unit responds using its own signal characteristics.

FIG. 2 illustrates a monitoring device 3 according to the invention. The monitoring device comprises polling means 11 for transmitting poll signals to one or more carrier devices 7 on an output connection 12. The monitoring device also comprises receiving means 13 for receiving response signals on an input connection 14 from the carrier devices and position means 15 for determining the position of each monitored item on the basis of characteristics of the response signal.

The monitoring device also comprises control means 17 for controlling the communication with the carrier device. The control means is preferably also arranged to receive position information from the position means 15 and initiate action if the distance between the monitoring device and the carrier device is greater than a preset threshold distance. The threshold distance can be selected as appropriate, but is preferably between 1 m and 30 m. The control means 17 may also, or alternatively, be arranged to take action if no response signal is received from a particular carrier unit, within a predetermined period of time. The control means 17 is preferably associated with, or communicates with, a control unit (not shown) of the mobile telephone 1. The control means 17 can instruct the control unit to control certain functions of the mobile telephone as required. Alternatively, the control means 17 is able to control functions of the mobile telephone directly, for example the display or sound generator. Communication with the control unit or other functional units of the telephone is illustrated in FIG. 2 by a connection 19, which enables transmission of signals from the control means to units of the mobile telephone, and possibly also input signals in the opposite direction. The control means 17 can also be arranged to control the communication functions of the mobile telephone, so that these functions can be used for communication between the monitoring device and the carrier devices 7.

The actions taken, either by the control means 17 or by the control unit of the mobile telephone, may be one or more of the following: The display of the mobile telephone may show the position of the carrier unit in question, or indicate in some way that the carrier unit is not responding, or is too far away. For example, a certain colour and/or flashing may be used. In addition, or alternatively, an alarm sound may be issued. The monitoring device may also transmit a deactivating signal to the carrier unit, instructing it to deactivate the function of the monitored item on which the carrier unit is arranged. The polling means 11 or another transmitter present in the may be used to transmit the deactivating signal.

Some or all of the control functions of the monitoring device 3 may advantageously be implemented on the SIM card of a mobile telephone.

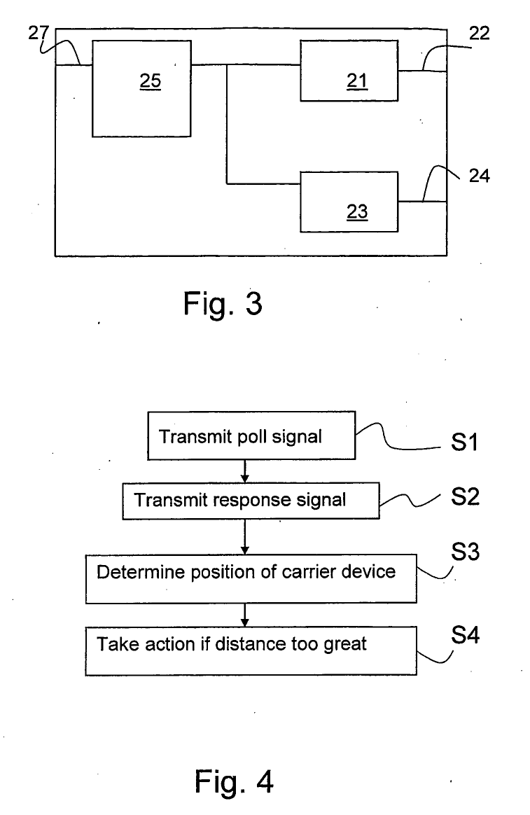

FIG. 3 shows in detail a carrier device 7 used in a monitored item according to the invention. The carrier device 7 comprises a receiving means 21 for receiving on an input connection 22 a poll signal from a monitoring device 3, and a response means 23 for transmitting on an output connection 24 a response signal to the monitoring device 3 in response to the poll signal. The carrier device also comprises a control means 25 for controlling the communication with the monitoring device. If different signal characteristics are used poll signals for different carrier devices, the control means 25 will determine if a signal received by the receiving means is intended for its carrier device 7 before responding or taking action. The control means 25 may also be arranged to communicate on a connection 27 with the monitored item 5 on which the carrier device is arranged, for example, to deactivate one or more functions on the item 5. The deactivation may be initiated by the control means 25 itself, if no poll signal is received within a predefined period of time. It may also be initiated by the control means 25 in response to a deactivation signal received from the monitoring device. The control means 25 may control the functions of the monitored item 5 directly, or via communication with a control unit (not shown) of the item 5. In the latter case, the control unit deactivates the functions.

The response means 23 may also be arranged to transmit a response signal according to its profile, without a poll signal having been received.

Each carrier has unique characteristics of its response means, enabling the monitoring device to determine which carrier it is communicating with.

The carrier device 7 may be arranged on any type of item. Typically it will be placed on, or integrated in, valuable items that are attractive to thieves, such as wallets, purses, handbags, credit cards, keys and remote controls for opening doors, or operating alarms, or other functions. It may also be used for identity devices. The carrier device can also be used to control heating, water and electricity or caring for pets. It may also form part of the security measures in organisations, companies, schools etc. Carriers according to the invention may be used to monitor a group of children, for example, a group of kindergarten or school children on a field trip.

If the monitored item already comprises a data storage and/or processing device, the carrier device functions could be implemented as part of this processing device. For use on a credit card, the carrier functions could be implemented on the electronic circuit (“chip”) currently found on all credit cards. In this case, the credit card function of the chip can easily be deactivated, permanently or for a limited period of time, by means of a simple code transmitted from the monitoring device, or if there is no communication between the monitoring device and the carrier. The chip will then be deactivated, making the credit card useless if it is removed too far from the monitoring device. The deactivation could be permanent or temporary. In the latter case the chip could be reactivated if a poll signal from the appropriate monitoring device is received at a later stage. The credit card will only work while it is within reach of the monitoring device. The signalling range of the monitoring device can be limited to set the maximum distance from the monitoring device at which the monitored item will still work.

FIG. 4 is a flow chart of the actions taken according to a basic embodiment of the invention.

In a first step, S1, a poll signal is transmitted from the monitoring device to at least one of the carrier devices associated with the monitoring device.

In step S2 the carrier device responds by sending a response signal to the monitoring device. In one embodiment the response signal can be transmitted even if the carrier device has not received a poll signal from the monitoring device.

In step S3 the position of the carrier device is determined by the position means of the monitoring device. It is not necessary to determine the exact position in order to know when to take action. Determining the distance between the monitoring device and the carrier device will be sufficient.

In step S4 action is taken if the distance is too great compared to a predetermined threshold. Examples of actions that may be taken are defined above.

1. A portable monitoring device for characterized in that it is comprises:
monitoring means for monitoring the presence of at least one monitored item, said monitoring means comprising:
polling means (11) for transmitting a poll signal to at least one carrier device arranged on a monitored item, said poll signal having predetermined characteristics identifying the monitoring device (3) and the carrier,
receiving means (13) for receiving a response signal from the monitored item,
position means (15) for identifying the monitored item on the basis of characteristics of the response signal, and
output means (12) for controlling the function of a communication device on which the monitoring device is arranged.

2. A monitoring device according to claim 1, wherein the position means is arranged to determine the position of the monitored item on the basis of characteristics of the response signal.

3. A monitoring device according to claim 1 wherein the monitoring device further has action means (17) for taking action if the position means determines that the distance between the monitoring device and the monitored item is greater than a predefined threshold distance.

4. A monitoring device according to claim 1, wherein the monitoring device further has action means (17) for taking action if no response signal is received within a predetermined period of time.

5. A monitoring device according to claim 3, wherein said action means (17) is arranged to take action by transmitting a deactivating signal to deactivate the monitored item.

6. A monitoring device according to claim 3, wherein said action means (17) is arranged to take action by issuing an alarm.

7. A monitoring device according to claim 7, wherein the action means (17) is arranged to activate a camera associated with the transmitting unit.

8. A monitoring device according to claim 3, wherein the action means (17) is arranged to display the determined position of the monitored item on a display screen.

9. A monitoring device according to claim 1, wherein the polling means (11) is a short-range transmitter.

10. A monitoring device according to claim 1, wherein the polling means (11) is arranged to transmit the poll signal on a radio frequency.

11. A monitoring device according to claim 1, wherein the polling means (11) is arranged to transmit the poll signal by means of a telecommunications network.

12. (canceled)

13. A carrier device arranged to be placed on a monitored item comprising:
receiving means (21) for receiving a poll signal from a monitoring device, said poll signal having predetermined characteristics identifying the monitoring device and the carrier,
response means (23) for transmitting a response signal to the monitoring device, said response signal enabling the monitoring device to identify the carrier device, and
deactivation means (25) for deactivating a function of the monitored item in response to a deactivating signal received from the monitoring device.

14. The carrier device according to claim 13, wherein the response means (23) is arranged to transmit the response signal in response to the poll signal.

15. The carrier device according to claim 13, wherein the response means is arranged to transmit a response signal enabling the monitoring device to determine the position of the carrier device.

16. (canceled)

17. A carrier device according to claim 13, further comprising deactivation means (25) for deactivating a function of the monitored item if no poll signal has been received from the monitoring device in a predefined period of time.

18. A carrier device according to claim 13 wherein said response means is a short-range transmitter.

19. A carrier device according to claim 13, wherein said response means is a radio frequency transmitter.

20. A carrier device according to claim 13, wherein said response means is arranged to transmit the response signal through a telecommunications network.

21. A carrier device according to claim 13, further comprising output means for controlling the function of an item on which the carrier device is arranged.

22. A method for monitoring the presence of a monitored item comprising:
transmitting a poll signal from a monitoring device to a carrier device arranged on the monitored item, said poll signal having predetermined characteristics identifying the monitoring device and the carrier device,
transmitting a response signal from the carrier device to the monitoring device, said response signal enabling the monitoring device to determine the position of the carrier device,
taking action if it is determined that the distance between the monitoring device and the carrier device is greater than a predetermined threshold distance,
deactivation by the carrier device of a function of the monitored item,
transmitting a deactivating signal from the monitoring device to the carrier device, and
taking action if no response signal is received in the monitoring device within a predefined period of time.

23. A method according to claim 22, wherein the response signal is transmitted in response to the poll signal

24. (canceled)

25. A method according to claim 24 wherein the step of taking action includes issuing an alarm.

26. (canceled)

27. A method according to claim 22 wherein the method further comprises the step of taking action if no poll signal is received in the carrier device within a predetermined period of time.

28. (canceled)

29. A method according to claim 22 wherein the method further comprises the step of displaying the position of the carrier device on a display unit associated with the monitoring device.

30. (canceled)

31. (canceled)
